(19) United States
(12) Patent Application Publication
(10) Pub. No.: US 2010/0054756 A1
(43) Pub. Date: Mar. 4, 2010

(54) Optical modulator and optical transmitter using the same

(75) Inventors: Masato Nishihara, Kawasaki (JP); Tomoo Takahara, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/457,058

(22) Filed: May 29, 2009

(30) Foreign Application Priority Data
Aug. 29, 2008 (JP) 2008-221269

(51) Int. Cl. H04B 10/12

(52) U.S. Cl. 398/185

(57) ABSTRACT

In an optical modulator, a DQPSK modulating section, a waveguide optical amplifying section, and an RZ modulating section are cascade connected on an optical path between input and output ports, and power of RZ-DQPSK signal light output from the output port is monitored by a photodetector, to feed-back control the waveguide optical amplifying section by an output control section so that the monitored power becomes constant at a target level. As a result, a small and low-cost optical modulator that can reliably compensate respective losses in a phase modulating section and an intensity modulating section, and differences of the respective losses, can be realized.

### CROSS-REFERENCE TO RELATED APPLICATION

This application is based upon and claims the benefit of priority of the prior Japanese Patent Application No. 2008-221269, filed on Aug. 29, 2008, the entire contents of which are incorporated herein by reference.

### FIELD

The embodiments discussed herein are related to an optical modulator that adopts an optical modulation format combining phase modulation and intensity modulation used for optical communication, and an optical transmitter using the same.

### BACKGROUND

Recently, with an increase of transmission traffic, there are increasing demands for introduction of a next-generation optical transmission system that can transmit super-high speed optical signals of, for example, 40 gigabits/second (Gbit/s). Moreover, a transmission distance and spectral efficiency the same as those of the conventional optical transmission system of 10 Gbit/s are required for the next-generation optical transmission system.

As one means for realizing these demands, research and development has become active for an optical modulation format which combines phase modulation and intensity modulation such as Return to Zero Differential Phase Shift Keying (RZ-DPSK) and Carrier-Suppressed Return to Zero Differential Phase Shift Keying (CSRZ-DPSK), which have excellent proof strength against Optical Signal-to-Noise Ratio (OSNR) and nonlinear proof strength as compared to the Non Return to Zero (NRZ) modulation format applied to the conventional optical transmission system. Among these optical modulation formats, a Return to Zero Differential Quadrature Phase Shift Keying (RZ-DQPSK) modulation format that has a narrow spectrum feature, that is, a high spectral efficiency, is expected as one potential candidate of the optical modulation format in the next-generation optical transmission system.

FIG. 5 is a diagram illustrating a configuration example of a conventional optical transmitter that adopts the RZ-DQPSK modulation format. The conventional optical transmitter includes a signal light source 1, an optical modulator 2, a modulator driving section 3, and an erbium-doped fiber amplifier (EDFA) 4 as a post amplifier. Moreover, the optical modulator 2 has a DQPSK modulating section 21 and an RZ modulating section 22 cascade connected on an optical path between an input port 2_{IN} and an output port 2_{OUT}.

In the above-described optical modulator 2, a plurality of signals input from outside is multiplexed in a CDR/MUX circuit 31 of the modulator driving section 3, to generate two sets of complimentary data signals DATA1, /DATA1 and DATA2, /DATA2 having a bit rate half the bit rate of the bit rate of transmission light (for example, when RZ-DQPSK signal light having a bit rate of 40 Gbit/s is to be transmitted, a data signal and an inversion signal thereof having a bit rate of 20 Gbit/s are generated), and complimentary clock signals CLK, /CLK synchronized with the data signals. The data signals DATA1, /DATA1 and DATA2, /DATA2 and the clock signals CLK and /CLK generated in the CDR/MUX circuit 31, are respectively amplified by driver amplifiers 32A and 32B and a driver amplifier 33, to drive the DQPSK modulating section 21 and the RZ modulating section 22.

In the DQPSK modulating section 21, continuous light output from the signal light source 1 and provided to the input port 2_{IN} of the optical modulator 2 is phase-modulated according to the data signals DATA1, /DATA1 and DATA2, /DATA2 output from the respective driver amplifiers 32A and 32B, to thereby generate DQPSK-modulated light. On the other hand, in the RZ modulating section 22, the DQPSK-modulated light output from the DQPSK modulating section 21 is intensity-modulated according to the clock signals CLK and /CLK output from the driver amplifier 33, to thereby generate RZ-DQPSK modulated light. The RZ modulating section 22 operates as a so-called pulse carver.

The DQPSK modulating section 21 includes a Mach-Zehnder (MZ) optical waveguide 211 formed on a substrate having an electro-optic effect, and two MZ type optical waveguides 212A and 212B further provided on a pair of branching arms of the MZ type optical waveguide 211. Here, the MZ type optical waveguide 211 is referred to as a “parent Mach-Zehnder” and the MZ type optical waveguides 212A and 212B are referred to as “child Mach-Zehnders”. The continuous light input from the signal light source 1 to the DQPSK modulating section 21 is branched into two by the parent Mach-Zehnder 211 and respectively input to the child Mach-Zehnders 212A and 212B on each branching arm.

In the child Mach-Zehnders 212A and 212B, drive signals from the driver amplifiers 32A and 32B (data signals DATA1, /DATA1 and DATA2, /DATA2) are respectively applied to electrodes 213A and 213B arranged along the respective branching arms. Since a refractive index of each branching arm changes due to an electric field generated by the drive signals, the guided waves are phase-modulated according to transmission data. Phase-modulated light output from one of the two child Mach-Zehnders 212A and 212B (here, the child Mach-Zehnder 212B) is provided to a phase shift section 214, to thereby shift a phase by π/2. Moreover, the phase-modulated light output from the phase shift section 214 and the phase-modulated light output from the other child Mach-Zehnder 212A are multiplexed by the parent Mach-Zehnder 211. At this time, the phase of the light on one arm of the parent Mach-Zehnder 211 is modulated between 0 and π, and the phase of the light on the other arm is modulated between π/2 and 3π/2, and these are multiplexed to generate four-valued phase-modulated light, that is, DQPSK-modulated light. The DQPSK-modulated light is output to the RZ modulating section 22, and a part thereof is branched by a branching coupler 215 and provided to a photodetector (PD) 216, so that an output state of the DQPSK-modulated light is monitored. The monitoring result is used for bias control of the respective electrodes 213A and 213B, and the phase shift section 214.

The RZ modulating section 22 includes an MZ type optical waveguide 221 formed on a substrate having an electro-optic effect, and electrodes 222 respectively arranged along branching arms of the MZ type optical waveguide 221. In the RZ modulating section 22, the drive signals from the driver amplifier 33 (clock signals CLK and /CLK) are applied to the electrodes 222, and a refractive index of each branching arm changes due to the electric field generated by the drive signals. As a result, the DQPSK-modulated light from the DQPSK modulating section 21 is intensity-modulated (pulse carved) according to the clock signal, to thereby generate RZ-DQPSK-modulated light. The RZ-DQPSK-modulated light is output to the EDFA 4 serving as the post amplifier, and a part thereof is branched by a branching coupler 223 and provided to a photodetector (PD) 224, so that an output state of the RZ-DQPSK-modulated light is monitored. The monitoring result is used for bias control of the respective electrodes 222. In the EDFA 4, the RZ-DQPSK-modulated light is amplified according to a required transmission light power, and the amplified RZ-DQPSK-modulated light is transmitted to an external optical fiber transmission line or the like as output light of the optical transmitter.

Incidentally, the RZ-DQPSK optical modulator 2 used in the above-described conventional optical transmitter generally uses a separate optical modulator as the DQPSK modulating section 21 and the RZ modulating section 22. As the respective optical modulators, for example, an LN modulator using a crystal substrate comprising a lithium niobate (LiNbO₃:LN) is used, and an optical fiber is used for splice-connecting the two LN modulators. However, if two optical modulators are separately used, a size increase of the entire optical modulator becomes a problem. As a conventional technique to cope with this problem, there is proposed a configuration in which the DQPSK modulating section and the RZ modulating section are integrated on a common substrate, to decrease the size of the entire optical modulator (for example, refer to M. Sugiyama et al., “Low-drive-voltage and compact RZ-DQPSK LiNbO₃ Modulator”, ECOC 2007, paper 10.3.4).

However, in the conventional optical transmitter described above, a loss in the RZ-DQPSK optical modulator is large, and the loss varies, causing the following problem. That is to say, as illustrated in FIG. 5, the RZ-DQPSK optical modulator 2 is configured with the DQPSK modulating section 21 and the RZ modulating section 22 cascade connected, and a loss occurs in the respective modulating sections, and for the entire optical modulator, the loss becomes relatively large, for example, 10 dB or more. The power of the RZ-DQPSK signal light (transmission light power) transmitted from the optical transmitter to the optical fiber transmission line or the like needs to be a required level or higher so that the transmission characteristic is not deteriorated due to an influence of noise and the like. Therefore, if the loss in the optical modulator 2 increases as described above, a means for compensating for the loss becomes necessary separately. In the configuration example of FIG. 5, the transmission light power is adjusted including loss compensation of the optical modulator 2, by the EDFA 4 connected to an output of the optical modulator 2. Such a loss compensating device of the optical modulator is required regardless of whether the DQPSK modulating section 21 and the RZ modulating section 22 are integrated, which becomes a restriction in achieving downsizing of the entire optical transmitter, and becomes a factor of increasing the cost of the apparatus.

For example, a loss of ±5 dB or larger may occur in the optical modulator 2 due to individual differences, temperature dependency, wavelength dependency, aging, and differences in modulation loss, associated with respective losses of the DQPSK modulating section 21 and the RZ modulating section 22. Moreover, when the optical fiber splice-connects the DQPSK modulating section 21 and the RZ modulating section 22, the splice state also becomes a factor of a loss difference. If the loss difference of the optical modulator 2 increases, power variation of the RZ-DQPSK signal light output from the optical modulator 2 increases. The power variation may further increase due to differences in output power of the signal light source 1. If variation of the RZ-DQPSK signal light output from the optical modulator 2 increases, a dynamic range of an input power of an optical amplifier arranged on a subsequent stage expands, and hence, the optical amplifier needs to have high performance. Moreover, differences also occur in monitor values of the respective photodetectors 216 and 224, due to differences in the respective losses of the DQPSK modulating section 21 and the RZ modulating section 22. Therefore a circuit (not illustrated) that performs bias control of the respective modulating sections based on the monitor values needs to have high performance as well.

The above-described problems are common not only to a configuration in which the optical transmitter is formed by using the RZ-DQPSK optical modulator, but also to a configuration in which the optical transmitter is formed by using an optical modulator combining a phase modulating section corresponding to a known phase modulation format other than DQPSK, with an intensity modulating section corresponding to a known intensity modulation format other than RZ.

### SUMMARY

According to an aspect of the invention, an optical modulator that has a phase modulating section and an intensity modulating section cascade connected on an optical path between an input port and an output port, and that modulates light input to the input port by the phase modulating section and the intensity modulating section and outputs the modulated light from the output port. The optical modulator includes a waveguide optical amplifying section provided on the optical path between the input port and the output port, an output monitoring section that monitors power of modulated light output from the output port, and an output control section that feed-back controls the waveguide optical amplifying section so that the output power of the modulated light monitored by the output monitoring section becomes constant at a predetermined target level.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration of a first embodiment of an optical transmitter.

FIG. 2 is a diagram illustrating a configuration of a second embodiment of an optical transmitter.

FIG. 3 is a diagram illustrating a configuration of a third embodiment of an optical transmitter.

FIG. 4 is a diagram illustrating a configuration of a fourth embodiment of an optical transmitter.

FIG. 5 is a diagram illustrating a configuration example of a conventional optical transmitter that uses an RZ-DQPSK optical modulator.

### DESCRIPTION OF EMBODIMENTS

Hereunder is a description of embodiments, with reference to the accompanying drawings.

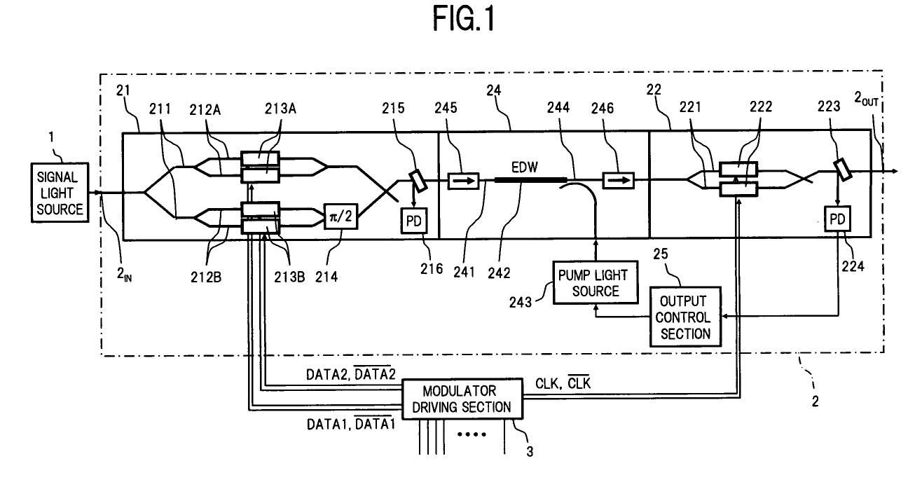

FIG. 1 is a diagram illustrating a configuration of a first embodiment of an optical transmitter.

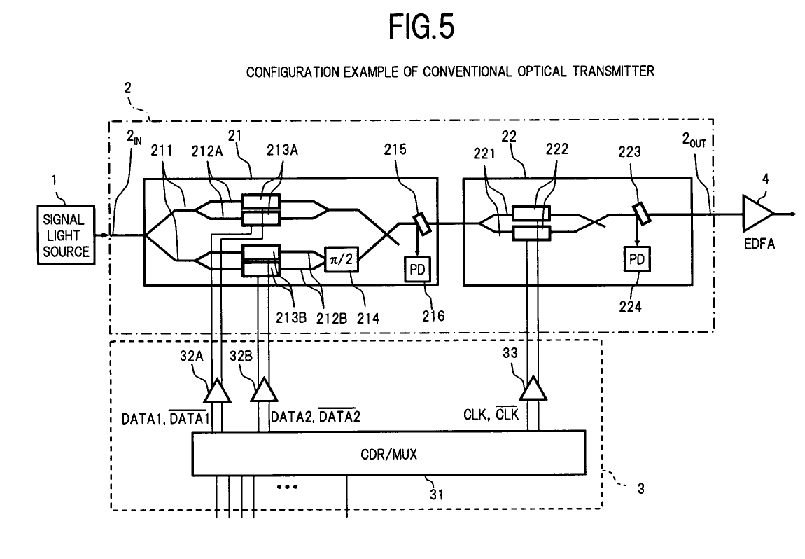

In FIG. 1, the optical transmitter of the first embodiment includes, for example, a signal light source 1, an RZ-DQPSK optical modulator 2, and a modulator driving section 3. The optical modulator 2 includes a DQPSK modulating section 21 and an RZ modulating section 22 similar to those in the conventional configuration illustrated in FIG. 5, and is additionally provided with a waveguide optical amplifying section 24 arranged between the DQPSK modulating section 21 and the RZ modulating section 22, and an output control section 25 that controls the waveguide optical amplifying section 24 so that power of RZ-DQPSK signal light (transmission light power) output from the RZ modulating section 22 becomes constant at a required level. The configuration of the waveguide optical amplifying section 24 and the output control section 25 additionally provided in this embodiment will be described below in detail. Parts common to the abovementioned conventional configuration are denoted by the same reference symbols, and description thereof is omitted.

The optical amplifying section 24 has an optical waveguide 241 that connects between, for example, a signal output terminal of the DQPSK modulating section 21 and a signal input terminal of the RZ modulating section 22. An erbium-doped waveguide (EDW) 242 in which erbium ions (Er³⁺) are doped to a part of a lengthwise section of the optical waveguide 241 is formed on the optical waveguide 241 as an optical amplifying medium. Pump light output from a pump light source 243 is applied to the EDW 242 from the back via a WDM coupler 244. The pump light source 243 generates pump light having a wavelength capable of pumping the erbium ions in the EDW 242, and the power of the pump light is controlled according to a control signal from the output control section 25. Moreover optical isolators 245 and 246 that block passage of light propagating in a direction opposite to the signal light, are arranged on the optical waveguide 241 positioned before and after the EDW 242.

Since the optical amplifying section 24 has a waveguide structure, integration of the DQPSK modulating section 21 and the RZ modulating section 22 can be easily realized. Specifically, the DQPSK modulating section 21, the RZ modulating section 22, and the optical amplifying section 24 can be integrated on a common substrate by using a substrate of the same material as that used for the DQPSK modulating section 21 and the RZ modulating section 22, for the optical amplifying section 24. For example, when the DQPSK modulating section 21 and the RZ modulating section 22 are constructed by using an LN substrate, the EDW can be formed on the LN substrate as the optical amplifying section 24. The erbium doped waveguide amplifier (EDWA) using such an LN substrate is disclosed, for example, in the literature: R. Brinkmann et al., “Erbium-Doped Single- and Double-Pass Ti:LiNbO₃ Waveguide Amplifiers”, IEEE Journal of Quantum Electronics, Vol. 30, No. 10, October 1994 or the like, and the technique can be applied to the optical amplifying section 24. In this way, since there is no loss at the boundary between respective sections by integrating the DQPSK modulating section 21, the RZ modulating section 22, and the optical amplifying section 24 on a common substrate, the loss and differences of the loss in the entire optical modulator can be further reduced.

Moreover even when a material different from that of the substrate for the DQPSK modulating section 21 and the RZ modulating section 22 is used as the substrate for the optical amplifying section 24, by designing the waveguide of the optical amplifying section 24, taking into consideration the waveguide structure of the DQPSK modulating section 21 and the RZ modulating section 22, the loss in the connection part between the respective sections can be suppressed to the minimum, thereby enabling to reduce the loss and differences of the loss in the entire optical modulator as compared to the case of the conventional splice connection using the optical fiber. Specifically, in an example using the LN substrate, when a gain required for compensating the loss generated in the DQPSK modulating section 21 and the RZ modulating section 22 can be hardly realized in the EDWA using the LN substrate, an EDWA using, for example, a silica (SiO₂) substrate can be used for the optical amplifying section 24. As for the silica-based EDWA, products such as “Metro EDWA series” manufactured by Teem Photonics are commercially available, and amplification characteristics where a small signal gain with respect to C-band signal light is equal to or larger than 27 dB and a saturation power is equal to or larger than 15 dB are realized. Such amplification characteristics can sufficiently compensate the loss generated in the DQPSK modulating section 21 and the RZ modulating section 22.

One example using the EDWA as the optical amplifying section 24 is illustrated here, however, the present invention is not limited thereto, and the optical amplifying section can be constructed by using, for example, a semiconductor optical amplifier (SOA). When the SOA is used, if a configuration using a semiconductor substrate for the DQPSK modulating section 21 and the RZ modulating section 22 is applied, the DQPSK modulating section 21, the RZ modulating section 22, and the optical amplifying section 24 can be integrated on the common semiconductor substrate. As such a semiconductor MZ optical modulator, for example, a “40 Gbit/s InP Mach-Zehnder-Modulator” manufactured by Heinrich-Hertz-Institute is well known.

In the configuration of FIG. 1, one example of backward pumping of the EDW 242 is illustrated, however, forward pumping or bi-directional pumping can also be used. Moreover, one example in which erbium ions are added to the optical waveguide as the optical amplifying medium is illustrated, however, rare earth ions other than erbium ions can be added to the optical waveguide to form the optical amplifying medium.

The output control section 25 feed-back controls drive conditions of the pump light source 243, that is, the power of the pump light supplied to the EDW 242, according to a monitor value of an output power (transmission light power) of the RZ-DQPSK modulated light obtained from a branching coupler 223 and a photodetector 224 provided in the RZ modulating section 22 similar to the conventional RZ modulating section, so that the monitor value becomes constant at a predetermined target level. Here the branching coupler 223 and the photodetector 224 have a function as an output monitor.

Next is a description of an operation in the first embodiment.

In the optical transmitter having the above-described configuration, continuous wave light output from the signal light source 1 is provided to the DQPSK modulating section 21 via an input port 2_{IN} of the optical modulator 2. In the DQPSK modulating section 21, two sets of complimentary data signals DATA1, /DATA1 and DATA2, /DATA2 output from the modulator driving section 3 are applied to respective electrodes 213A and 213B of the child Mach-Zehnder, to modulate a phase of the continuous light according to the data signal, thereby generating the DQPSK modulated light. The power of the DQPSK modulated light drops below the power of the continuous wave light output from the signal light source 1 due to the loss in the DQPSK modulating section 21, and the power of the DQPSK modulated light fluctuates due to the aforementioned factors such as individual differences, temperature dependency, wavelength dependency, aging, and differences in modulation loss, of the DQPSK modulating section 21.

The DQPSK modulated light generated in the DQPSK modulating section 21 is provided to the optical waveguide 241 in the optical amplifying section 24, and delivered to the EDW 242 via the optical isolator 245. The pump light from the pump light source 243 is supplied to the EDW 242 via the WDM coupler 244, and the DQPSK modulated light that propagates on the EDW 242 is amplified by an induced emission phenomenon of the erbium ions pumped by the pump light. The amplified DQPSK modulated light passes through the WDM coupler 244 and the optical isolator 246, and is delivered to the RZ modulating section 22.

In the RZ modulating section 22, the complimentary clock signals CLK and /CLK output from the modulator driving section 3 are applied to electrodes 222, and the intensity of the DQPSK modulated light amplified by the optical amplifying section 24 is modulated according to the clock signals to thereby generate the RZ-DQPSK modulated light. The power of the RZ-DQPSK modulated light also drops below the power of the amplified DQPSK modulated light output from the optical amplifying section 24 due to the loss in the RZ modulating section 22, and the power of the RZ-DQPSK modulated light fluctuates due to the factors such as individual differences of the RZ modulating section 22, similarly to the aforementioned case of the DQPSK modulating section 21.

The RZ-DQPSK modulated light generated in the RZ modulating section 22 is transmitted to an external optical fiber transmission line or the like connected to an output port 2_{OUT} of the optical modulator 2, as output light of the optical transmitter, without going via the post amplifier in the conventional configuration. A part of the RZ-DQPSK modulated light is branched by the branching coupler 223, and the power of the branched light is monitored by the photodetector 224. The monitoring result of the photodetector 224 is transmitted to the output control section 25 and used for controlling the optical amplifying section 24, and is also used for bias control of the RZ modulating section 22 as in the conventional configuration, although not illustrated.

The output control section 25 obtains a difference between the monitor value of the output power (transmission light power) of the RZ-DQPSK modulated light transmitted from the photodetector 224 and a predetermined target level, and feedback-controls the power of the pump light output from the pump light source 243 in the optical amplifying section 24 so that the difference becomes zero, that is, the output power of the RZ-DQPSK modulated light becomes constant at the target level. As a result, respective losses in the DQPSK modulating section 21 and the RZ modulating section 22 and the differences of the respective losses are automatically compensated by the optical amplifying section 24. Moreover, differences in the output power of the signal light source 1 are also similarly automatically compensated.

According to the optical transmitter of the first embodiment described above, even if there is a large loss exceeding 10 dB in the DQPSK modulating section 21 and the RZ modulating section 22 and the loss varies due to factors such as the individual differences of the DQPSK modulating section 21 and the RZ modulating section 22, the loss can be automatically compensated in the optical modulator 2, and the RZ-DQPSK signal light having a desired power can be stably transmitted to the external optical fiber transmission line or the like from the optical transmitter, without a separate external post amplifier as in the conventional configuration. As a result, downsizing of the optical transmitter can be realized at a low cost.

In the first embodiment, one example in which the waveguide optical amplifying section 24 is arranged between the DQPSK modulating section 21 and the RZ modulating section 22 is illustrated. However, the arrangement of the optical amplifying section 24 in the optical modulator 2 is not limited thereto, and the optical amplifying section 24 can be provided between the input port 2_{IN} and the DQPSK modulating section 21, or between the RZ modulating section 22 and the output port 2_{OUT}. However, when the optical amplifying section 24 is provided on a previous stage of the DQPSK modulating section 21, since the continuous wave light having a relatively large power is input from the signal light source 1 to the optical amplifying section 24, the gain may be restricted due to a limit of the maximum output power of the optical amplifying section 24. Moreover when the optical amplifying section 24 is provided on the subsequent stage of the RZ modulating section 22, since the RZ-DQPSK signal light having a small power attenuated by the DQPSK modulating section 21 and the RZ modulating section 22 is input to the optical amplifying section 24, this may be disadvantageous for the NF characteristic. Taking these possibilities into consideration, it is desired to arrange the optical amplifying section 24 in the optical modulator 2 between the DQPSK modulating section 21 and the RZ modulating section 22.

Next is a description of a second embodiment of an optical transmitter.

Since the first embodiment is configured such that the power of the pump light of the optical amplifying section 24 is feed-back controlled according to the monitor value of the output light power of the optical transmitter, when the output light power of the optical modulator 2 fluctuates due to differences in the output power of the signal light source 1 or differences of the respective losses in the DQPSK modulating section 21 and the RZ modulating section 22, the gain of the optical amplifying section 24 changes accompanying this. When the gain of the optical amplifying section 24 changes, the power of noise light generated in the optical amplifying section 24, that is, the amplified spontaneous emission (ASE) amplified in the EDW 242 also changes. This change in the ASE power may degrade an accuracy of the monitor value of the output light power in the photodetector 224 arranged on the subsequent stage of the optical amplifying section 24, and may decrease the accuracy of automatic compensation of the loss or the accuracy of the bias control of the RZ modulating section 22. Therefore, in the second embodiment, an application example in which a decrease of the accuracy is avoided by applying gain constant control to the optical amplifying section 24 will be explained.

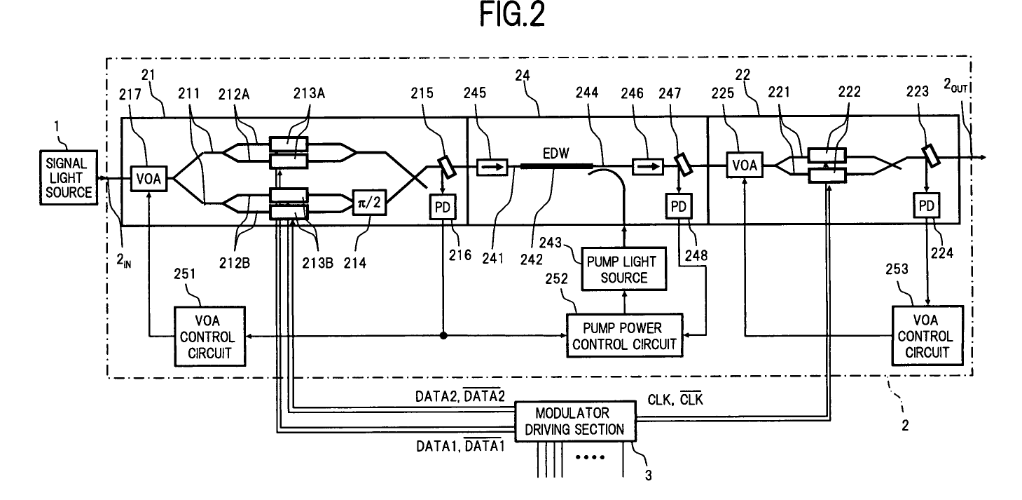

FIG. 2 illustrates a configuration of the optical transmitter of the second embodiment.

In the optical transmitter illustrated in FIG. 2, a variable optical attenuator (VOA) 217 is inserted on the input waveguide of the DQPSK modulating section 21 in the configuration of the first embodiment illustrated in FIG. 1, and a VOA control circuit 251 that feedback-controls an attenuation of the VOA 217 so that the output power of the DQPSK modulated light monitored by the photodetector 216 becomes constant, is provided.

The optical amplifying section 24 includes a branching coupler 247 that branches a part of the DQPSK modulated light propagated on the EDW 242 and amplified, and a photodetector (PD) 248 that monitors the power of the branched light. The optical amplifying section 24 also includes a pump power control circuit 252 that feedback-controls the pump light source 243 so that the gain of the optical amplifying section 24 obtained by using the monitor value by the photodetector 216 in the DQPSK modulating section 21 (input light power to the optical amplifying section 24) and the monitor value by the photodetector 248 (output light power from the optical amplifying section 24) becomes constant.

Furthermore in the RZ modulating section 22, a variable optical attenuator (VOA) 225 is inserted on the input waveguide, and a VOA control circuit 253 that feedback-controls an attenuation amount of the VOA 225 so that the output power of the RZ-DQPSK modulated light monitored by the photodetector 225 becomes constant, is provided.

In the above-described configuration, the VOA 217 in the DQPSK modulating section 21 and the VOA 225 in the RZ modulating section 22 function as an input power adjusting section. Moreover the branching coupler 215 and the photodetector 216 in the DQPSK modulating section 21, and the branching coupler 247 and the photodetector 248 in the optical amplifying section 24 function as a gain monitoring section. Furthermore the VOA control circuits 251 and 253 function as an input power control circuit comprising the output control section, and the pump power control circuit 252 functions as the optical amplification control circuit comprising the output control section.

In the optical transmitter having such a configuration, the differences of the respective losses in the DQPSK modulating section 21 and the RZ modulating section 22 are automatically compensated by the feed-back control of the VOAs 217 and 225 by the VOA control circuits 251 and 253, for each of the modulating sections 21 and 22. As a result, the sum of the losses in the DQPSK modulating section 21 and the RZ modulating section 22 becomes substantially constant. Furthermore even when the output power of the signal light source 1 varies, the differences can be compensated by the feed-back control of the VOA 217 in the DQPSK modulating section 21. Moreover, by controlling the gain of the optical amplifying section 24 to be constant by the pump power control circuit 252, associated with the sum of losses in the DQPSK modulating section 21 and the RZ modulating section 22, the loss of the entire optical modulator 2 can be compensated and a change in the ASE power generated in the optical amplifying section 24 can be suppressed.

As a result, since ASE components included in the respective input lights to the photodetectors 248 and 224 positioned on the subsequent stage of the EDW 242 become substantially constant, even when there are differences in the output power of the signal light source 1 or differences of the respective losses in the DQPSK modulating section 21 and the RZ modulating section 22, the power of the modulated light can be monitored with high accuracy in the respective photodetectors 248 and 224. Accordingly, the RZ-DQPSK signal light having a desired power can be transmitted more stably from the optical transmitter to the external optical fiber transmission line or the like.

Next is a description of a third embodiment of an optical transmitter.

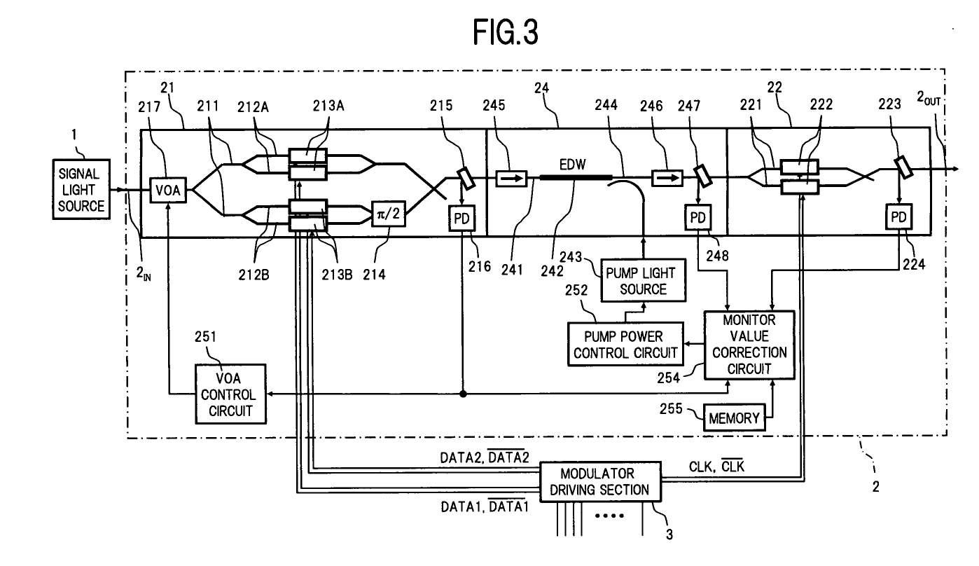

FIG. 3 is a diagram illustrating a configuration of the optical transmitter of the third embodiment. The optical transmitter in FIG. 3 includes a monitor value correcting circuit 254 and a memory 255 instead of the VOA 225 and the VOA control circuit 253 corresponding thereto provided in the RZ modulating section 22 in the configuration of the second embodiment illustrated in FIG. 2. Power monitor values in the photodetector 216 in the DQPSK modulating section 21, in the photodetector 248 in the optical amplifying section 24, and in the photodetector 224 in the RZ modulating section 22 are respectively provided to the monitor value correcting circuit 254.

The monitor value correcting circuit 254 first calculates the gain of the optical amplifying section 24 by using the monitor values of the respective photodetectors 216 and 248 in the DQPSK modulating section 21 and the optical amplifying section 24. Then the monitor value of the photodetector 224 in the RZ modulating section 22 is corrected according to the calculated gain. The correction of the monitor value is performed to reduce a discrepancy in the monitor value generated due to a change in a yield of the ASE, when the gain of the optical amplifying section 24 changes due to differences of the loss of the optical modulator 2. Specifically, for example, data indicating a relation between the gain of the optical amplifying section 24 and an amount of discrepancy in the monitor value is acquired beforehand and stored in the memory 255, and the amount of discrepancy in the monitor value corresponding to the calculated gain is read from the memory 255, to thereby correct the monitor value of the photodetector 224 by using the amount of discrepancy.

When the monitor value of the photodetector 224 in the RZ modulating section 22 is corrected corresponding to the gain of the optical amplifying section 24 in the above manner, the corrected monitor value is transmitted to the pump power control circuit 252. The pump power control circuit 252 feedback-controls the power of the pump light output from the pump light source 243 in the optical amplifying section 24 so that the output value from the monitor value correcting circuit 254, that is, the output power (transmission light power) of the RZ-DQPSK modulated light becomes constant at the target level. As a result, the loss of the optical modulator 2 and the differences in the loss are automatically compensated by the optical amplifying section 24. Moreover, here the differences in the output power of the signal light source 1 and the differences of the loss in the DQPSK modulating section 21 are compensated by the VOA 217 and the VOA control circuit 251 that correspond to the DQPSK modulating section 21.

According to the optical transmitter of the third embodiment, since an effect similar to that of the second embodiment can be obtained, and the VOA 225 on the input waveguide in the RZ modulating section 22 used in the second embodiment can be omitted, the optical modulator 2 can be downsized at a low cost.

In the third embodiment, one example in which the VOA 217 and the VOA control circuit 251 are provided for the DQPSK modulating section 21 is illustrated, however, the VOA 217 and the VOA control circuit 251 can be omitted. In this case, the differences in the output power of the signal light source 1 and the differences of the loss in the DQPSK modulating section 21 are collectively compensated by the output constant control executed by the monitor value correcting circuit 254 and the pump power control circuit 252. The optical modulator 2 can be further downsized by applying such a configuration.

Next is a description of a fourth embodiment of an optical transmitter.

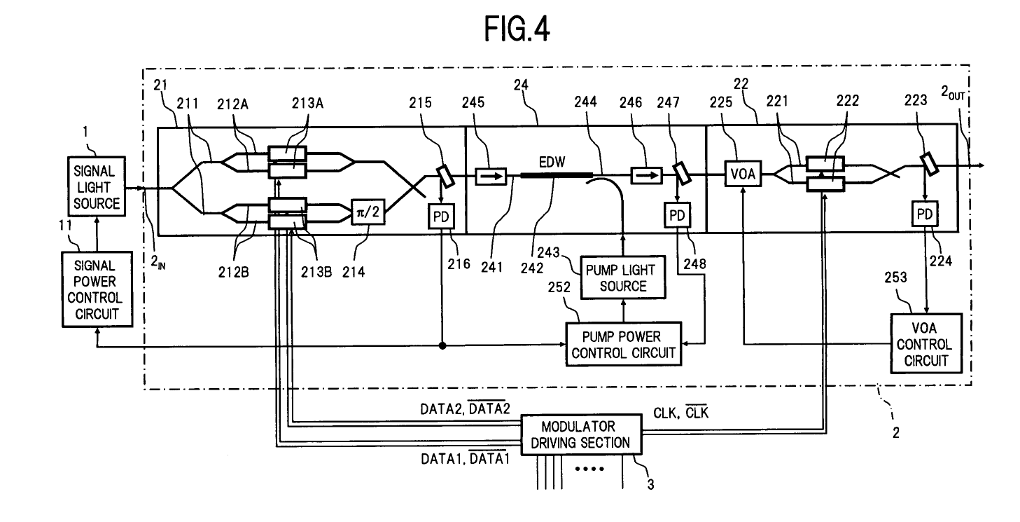

FIG. 4 is a diagram illustrating a configuration of the optical transmitter of the fourth embodiment. The optical transmitter in FIG. 4 includes a signal power control circuit 11 instead of the VOA 217 and the VOA control circuit 251 corresponding thereto provided in the DQPSK modulating section 21 in the configuration of the second embodiment illustrated in FIG. 2. The signal power control circuit 11 feedback-controls the output power of the signal light source 1 so that the monitor value of the photodetector 216 in the DQPSK modulating section 21 becomes constant. The configurations of other parts are the same as those in the second embodiment.

According to the fourth embodiment, since effects similar to those of the second embodiment can be obtained, and the VOA 217 on the input waveguide in the DQPSK modulating section 21 used in the second embodiment can be omitted, the optical modulator 2 can be downsized at a low cost.

In the first to the fourth embodiments, a case where the optical transmitter is constructed by using the RZ-DQPSK optical modulator has been described. However, the optical modulation format in the present invention is not limited to the RZ-DQPSK modulation format, and the configurations of the first to the fourth embodiments can be applied when the optical transmitter is constructed by using an optical modulator combining a phase modulating section corresponding to a well-known phase modulation format (for example, the DPSK modulation format) and an intensity modulating section corresponding to a well-known intensity modulation format (for example, the CSRZ modulation format).

Moreover, the configuration example has been described in which normal-phase modulated light, that is, the modulated light output from an upper output of two outputs of a coupler on an output side in the Mach-Zehnder optical waveguide (in the case of the DQPSK modulating section 21, the parent Mach-Zehnder) illustrated in FIG. 1 to FIG. 4, is extracted as the monitor light of the output in the DQPSK modulating section 21 and the RZ modulating section 22. However, the inverted-phase modulated light output from the lower output of the two outputs of the coupler can be extracted as the monitor light. Which one of the normal phase and inverted phase is to be monitored, can be appropriately selected taking into consideration part sharing with a monitoring system in bias control of the respective modulating sections 21 and 22.

As described above, the waveguide optical amplifier is provided on the optical path between input and output ports in the optical modulator. However, the waveguide serving as the optical amplifying medium can be one in which erbium or the like is added to a planar waveguide or a coplanar waveguide.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An optical modulator that has a phase modulating section and an intensity modulating section cascade connected on an optical path between an input port and an output port, and that modulates light input to the input port by the phase modulating section and the intensity modulating section and outputs the modulated light from the output port, wherein the optical modulator comprises:
a waveguide optical amplifying section provided on the optical path between the input port and the output port;
an output monitoring section that monitors power of the modulated light output from the output port; and
an output control section that feed-back controls the waveguide optical amplifying section so that the output power of the modulated light monitored by the output monitoring section becomes constant at a predetermined target level.

2. An optical modulator according to claim 1, wherein the waveguide optical amplifying section is arranged between the phase modulating section and the intensity modulating section.

3. An optical modulator according to claim 1, comprising:
an input power adjusting section that adjusts power of the light input to at least one of the phase modulating section and the intensity modulating section; and
a gain monitoring section that monitors gain of the waveguide optical amplifying section,
and the output control section has an optical amplification control circuit that feed-back controls the waveguide optical amplifying section so that the gain monitored by the gain monitoring section becomes constant, and an input power control circuit that feed-back controls the input power adjusting section so that an output power of the modulated light monitored by the output monitoring section becomes constant at the target level.

4. An optical modulator according to claim 3, wherein
the phase modulating section has an output monitor that monitors power of the phase-modulated light;
the intensity modulating section has an output monitor that monitors power of the intensity-modulated light;
the input power adjusting section has a first variable optical attenuator that attenuates the light input to the phase modulating section, and a second variable optical attenuator that attenuates the light input to the intensity modulating section, and
the input power control circuit has a first optical attenuation control circuit that feed-back controls an optical attenuation amount of the first variable optical attenuator so that a monitor value of the output monitor in the phase modulating section becomes constant, and a second optical attenuation control circuit that feed-back controls an optical attenuation amount of the second variable optical attenuator so that a monitor value of the output monitor in the intensity modulating section becomes constant.

5. An optical modulator according to claim 1, comprising a gain monitoring section that monitors gain of the waveguide optical amplifying section,
and the output control section has a monitor value correction circuit that corrects the output power of the modulated light monitored by the output monitoring section according to the gain monitored by the gain monitoring section, and an optical amplification control circuit that feed-back controls the waveguide optical amplifying section so that the output power corrected by the monitor value correction circuit becomes constant.

6. An optical modulator according to claim 5, wherein
the phase modulating section, the waveguide optical amplifying section, and the intensity modulating section are cascade connected in sequence on the optical path between the input port and the output port, and
the phase modulating section has a variable optical attenuator that attenuates the input light, an output monitor that monitors power of the phase-modulated light, and an optical attenuation control circuit that feed-back controls an optical attenuation amount of the variable optical attenuator so that a monitor value of the output monitor becomes constant.

7. An optical modulator according to claim 1, wherein
the waveguide optical amplifying section has an optical amplifying medium formed by adding rare earth ions to an optical waveguide, a pump light source that generates pump light for pumping the optical amplifying medium, and a WDM coupler that provides the pump light output from the pump light source to the optical amplifying medium.

8. An optical modulator according to claim 1, wherein
the waveguide optical amplifying section includes a semiconductor optical amplifier.

9. An optical modulator according to claim 1, wherein
the phase modulating section, the intensity modulating section, and the waveguide optical amplifying section are integrated on a common substrate.

10. An optical modulator according to claim 9, wherein
the common substrate is a lithium niobate (LN) substrate.

11. An optical modulator according to claim 9, wherein
the common substrate is a semiconductor substrate.

12. An optical modulator according to claim 1, wherein
the phase modulating section includes a DQPSK or DPSK optical modulator.

13. An optical modulator according to claim 1, wherein
the intensity modulating section includes an RZ or CSRZ optical modulator.

14. An optical transmitter comprising a signal light source that generates continuous wave light, an optical modulator that modulates the continuous light from the signal light source, and a modulator driving section that drives the optical modulator, wherein
the optical modulator is an optical modulator according to claim 1.

15. An optical transmitter according to claim 14, wherein
in the optical modulator, the phase modulating section, the waveguide optical amplifying section, and the intensity modulating section are cascade connected in sequence on the optical path between the input port and the output port, and
the phase modulating section has an output monitor that monitors power of the phase-modulated light, and
the optical transmitter further comprises a signal power control circuit that feedback-controls the output power of the signal light source so that a monitor value of the output monitor in the phase modulating section becomes constant.
